(19) United States
(12) Patent Application Publication
(10) Pub. No.: US 2022/0391963 A1
(43) Pub. Date: Dec. 8, 2022

(54) COMPUTER-IMPLEMENTED METHOD, SYSTEM, AND COMPUTER PROGRAM PRODUCT FOR GROUP RECOMMENDATION

(71) Applicant: Visa International Service Association, San Francisco, CA (US)

(72) Inventors: Mina Ghashami, Sunnyvale, CA (US); Hossein Hamooni, San Carlos, CA (US)

(21) Appl. No.: 17/785,942

(22) PCT Filed: Dec. 17, 2019
(86) PCT No.: PCT/US19/66808

§ 371 Date: Jun. 16, 2022

(51) Int. Cl. G06Q 30/06; G06Q 30/02

(52) U.S. Cl. CPC G06Q 30/0631; G06Q 30/0204; G06Q 30/0255

(57) ABSTRACT

A computer-implemented method includes: generating a plurality of candidate groups based on transaction data associated with each user of a plurality of users, each candidate group of the plurality of candidate groups including a subset of users that conducted transactions with a common merchant within a threshold time; generating a plurality of actual groups based on the plurality of candidate groups and the transaction data associated with each user of the plurality of users, each actual group of the plurality of actual groups including a subset of users grouped together in at least a threshold plurality of candidate groups; and for an actual group of the plurality of actual groups, determining a classification associated with a merchant for the actual group based on transaction data for transactions conducted between the merchant and each user of the actual group.

### BACKGROUND

### 1. Technical Field

The disclosure relates to a method, system, and computer program product for group recommendation.

### 2. Technical Considerations

Recommendation engines generate recommendations of products or services for which a user may be interested. The recommendation engines may determine recommendations for individual users or for groups of users.

For group recommendation engines, several unique challenges are present. First, determining a plurality of users that form a real-world group can be difficult and can reflect the effectiveness of a group recommendation technique. Moreover, once a group is determined, generating the recommendation relevant to the group can also be challenging. Evaluating the effectiveness of the group recommendation technique can also be difficult.

### SUMMARY

Accordingly, and generally, provided is an improved computer-implemented method, system, and computer program product for group recommendation.

According to some non-limiting embodiments or aspects, a computer-implemented method includes: generating, with at least one processor, a plurality of candidate groups based on transaction data associated with each user of a plurality of users, each candidate group of the plurality of candidate groups including a subset of users that conducted transactions with at least one common merchant within a threshold time; generating, with at least one processor, a plurality of actual groups based on the plurality of candidate groups and the transaction data associated with each user of the plurality of users, each actual group of the plurality of actual groups including a subset of users grouped together in at least a threshold plurality of candidate groups; and for at least one actual group of the plurality of actual groups, determining, with at least one processor, a classification associated with a merchant for the at least one actual group based on transaction data for transactions conducted between the merchant and each user of the at least one actual group.

In some non-limiting embodiments or aspects, the at least one common merchant may include a restaurant merchant. The threshold time may include up to 10 minutes. Generating the plurality of actual groups may include: based on the transaction data, generating, with at least one processor, a weight undirected graph where each node corresponds a user and each edge corresponds to two users being included in a same candidate group of the plurality of candidate groups, where each edge is assigned a weight based on a number of same candidate groups in which the two users have been included together. The threshold plurality of candidate groups may include the weight exceeding a predetermined level. The classification may be based on an amount spent at the merchant by at least one user of the at least one actual group. The classification may be based on a number of times the at least one actual group has conducted transactions with the merchant. The method may include: receiving, with at least one processor, group recommendation data from a recommendation engine generating at least one recommendation not based on user transaction data; comparing, with at least one processor, at least one of the plurality of candidate groups, the plurality of actual groups, and the classification with the group recommendation data; and based on the comparison, generating, with at least one processor, a score associated with the recommendation engine. The method may include: communicating, with at least one processor, at least one of an offer message and an advertisement message to a computing device of at least one user of the at least one actual group based on the classification. The method may include: generating, with at least one processor, at least one merchant recommendation based on the classification; and communicating, with at least one processor, at least one of an offer message and an advertisement message to a computing device of at least one user of the at least one actual group based on the at least one merchant recommendation.

According to some non-limiting embodiments or aspects, a group recommendation system includes at least one processor programmed or configured to: generate a plurality of candidate groups based on transaction data associated with each user of a plurality of users, each candidate group of the plurality of candidate groups including a subset of users that conducted transactions with at least one common merchant within a threshold time; generate, a plurality of actual groups based on the plurality of candidate groups and the transaction data associated with each user of the plurality of users, each actual group of the plurality of actual groups including a subset of users grouped together in at least a threshold plurality of candidate groups; and for at least one actual group of the plurality of actual groups, determine a classification associated with a merchant for the at least one actual group based on transaction data for transactions conducted between the merchant and each user of the at least one actual group.

In some non-limiting embodiments or aspects, the at least one common merchant may include a restaurant merchant. The threshold time may include up to 10 minutes. Generating the plurality of actual groups may include: based on the transaction data, generating a weight undirected graph where each node corresponds a user and each edge corresponds to two users being included in a same candidate group of the plurality of candidate groups, where each edge is assigned a weight based on a number of same candidate groups in which the two users have been included together. The threshold plurality of candidate groups may include the weight exceeding a predetermined level. The classification may be based on an amount spent at the merchant by at least one user of the at least one actual group. The classification may be based on a number of times the at least one actual group has conducted transactions with the merchant. The at least one processor may be programmed or configured to: receive group recommendation data from a recommendation engine generating at least one recommendation not based on user transaction data; compare at least one of the plurality of candidate groups, the plurality of actual groups, and the classification with the group recommendation data; and based on the comparison, generate a score associated with the recommendation engine. The at least one processor may be programmed or configured to: communicate at least one of an offer message and an advertisement message to a computing device of at least one user of the at least one actual group based on the classification. The at least one processor may be programmed or configured to: generate at least one merchant recommendation based on the classification; and communicate at least one of an offer message and an advertisement message to a computing device of at least one user of the at least one actual group based on the at least one merchant recommendation.

According to some non-limiting embodiments or aspects, a computer program product for group recommendation includes at least one non-transitory computer-readable medium including one or more instructions that, when executed by at least one processor, cause the at least one processor to: generate a plurality of candidate groups based on transaction data associated with each user of a plurality of users, each candidate group of the plurality of candidate groups including a subset of users that conducted transactions with at least one common merchant within a threshold time; generate, a plurality of actual groups based on the plurality of candidate groups and the transaction data associated with each user of the plurality of users, each actual group of the plurality of actual groups including a subset of users grouped together in at least a threshold plurality of candidate groups; and for at least one actual group of the plurality of actual groups, determine a classification associated with a merchant for the at least one actual group based on transaction data for transactions conducted between the merchant and each user of the at least one actual group.

In some non-limiting embodiments or aspects, the at least one common merchant may include a restaurant merchant. The threshold time may include up to 10 minutes. Generating the plurality of actual groups may include: based on the transaction data, generating a weight undirected graph where each node corresponds a user and each edge corresponds to two users being included in a same candidate group of the plurality of candidate groups, where each edge is assigned a weight based on a number of same candidate groups in which the two users have been included together. The threshold plurality of candidate groups may include the weight exceeding a predetermined level. The classification may be based on an amount spent at the merchant by at least one user of the at least one actual group. The classification may be based on a number of times the at least one actual group has conducted transactions with the merchant. The one or more instructions may cause the at least one processor to: receive group recommendation data from a recommendation engine generating at least one recommendation not based on user transaction data; compare at least one of the plurality of candidate groups, the plurality of actual groups, and the classification with the group recommendation data; and based on the comparison, generate a score associated with the recommendation engine. The one or more instructions may cause the at least one processor to: communicate at least one of an offer message and an advertisement message to a computing device of at least one user of the at least one actual group based on the classification. The one or more instructions may cause the at least one processor to: generate at least one merchant recommendation based on the classification; and communicate at least one of an offer message and an advertisement message to a computing device of at least one user of the at least one actual group based on the at least one merchant recommendation.

Further non-limiting embodiments or aspects are set forth in the following numbered clauses:

Clause 1: A computer-implemented method comprising: generating, with at least one processor, a plurality of candidate groups based on transaction data associated with each user of a plurality of users, each candidate group of the plurality of candidate groups comprising a subset of users that conducted transactions with at least one common merchant within a threshold time; generating, with at least one processor, a plurality of actual groups based on the plurality of candidate groups and the transaction data associated with each user of the plurality of users, each actual group of the plurality of actual groups comprising a subset of users grouped together in at least a threshold plurality of candidate groups; and for at least one actual group of the plurality of actual groups, determining, with at least one processor, a classification associated with a merchant for the at least one actual group based on transaction data for transactions conducted between the merchant and each user of the at least one actual group.

Clause 2: The method of clause 1, wherein the at least one common merchant comprises a restaurant merchant.

Clause 3: The method of clause 1 or 2, wherein the threshold time comprises up to 10 minutes.

Clause 4: The method of any of clauses 1-3, wherein generating the plurality of actual groups comprises: based on the transaction data, generating, with at least one processor, a weight undirected graph wherein each node corresponds a user and each edge corresponds to two users being included in a same candidate group of the plurality of candidate groups, wherein each edge is assigned a weight based on a number of same candidate groups in which the two users have been included together.

Clause 5: The method of any of clauses 1-4, wherein the threshold plurality of candidate groups comprises the weight exceeding a predetermined level.

Clause 6: The method of any of clauses 1-5, wherein the classification is based on an amount spent at the merchant by at least one user of the at least one actual group.

Clause 7: The method of any of clauses 1-6, wherein the classification is based on a number of times the at least one actual group has conducted transactions with the merchant.

Clause 8: The method of any of clauses 1-7, further comprising: receiving, with at least one processor, group recommendation data from a recommendation engine generating at least one recommendation not based on user transaction data; comparing, with at least one processor, at least one of the plurality of candidate groups, the plurality of actual groups, and the classification with the group recommendation data; and based on the comparison, generating, with at least one processor, a score associated with the recommendation engine.

Clause 9: The method of any of clauses 1-8, further comprising: communicating, with at least one processor, at least one of an offer message and an advertisement message to a computing device of at least one user of the at least one actual group based on the classification.

Clause 10: The method of any of clauses 1-9, further comprising: generating, with at least one processor, at least one merchant recommendation based on the classification; and communicating, with at least one processor, at least one of an offer message and an advertisement message to a computing device of at least one user of the at least one actual group based on the at least one merchant recommendation.

Clause 11: A group recommendation system, comprising at least one processor programmed or configured to: generate a plurality of candidate groups based on transaction data associated with each user of a plurality of users, each candidate group of the plurality of candidate groups comprising a subset of users that conducted transactions with at least one common merchant within a threshold time; generate, a plurality of actual groups based on the plurality of candidate groups and the transaction data associated with each user of the plurality of users, each actual group of the plurality of actual groups comprising a subset of users grouped together in at least a threshold plurality of candidate groups; and for at least one actual group of the plurality of actual groups, determine a classification associated with a merchant for the at least one actual group based on transaction data for transactions conducted between the merchant and each user of the at least one actual group.

Clause 12: The system of clause 11, wherein the at least one common merchant comprises a restaurant merchant.

Clause 13: The system of clause 11 or 12, wherein the threshold time comprises up to 10 minutes.

Clause 14: The system of any of clauses 11-13, wherein generating the plurality of actual groups comprises: based on the transaction data, generating a weight undirected graph wherein each node corresponds a user and each edge corresponds to two users being included in a same candidate group of the plurality of candidate groups, wherein each edge is assigned a weight based on a number of same candidate groups in which the two users have been included together.

Clause 15: The system of any of clauses 11-14, wherein the threshold plurality of candidate groups comprises the weight exceeding a predetermined level.

Clause 16: The system of any of clauses 11-15, wherein the classification is based on an amount spent at the merchant by at least one user of the at least one actual group.

Clause 17: The system of any of clauses 11-16, wherein the classification is based on a number of times the at least one actual group has conducted transactions with the merchant.

Clause 18: The system of any of clauses 11-17, wherein the at least one processor is programmed or configured to: receive group recommendation data from a recommendation engine generating at least one recommendation not based on user transaction data; compare at least one of the plurality of candidate groups, the plurality of actual groups, and the classification with the group recommendation data; and based on the comparison, generate a score associated with the recommendation engine.

Clause 19: The system of any of clauses 11-18, wherein the at least one processor is programmed or configured to: communicate at least one of an offer message and an advertisement message to a computing device of at least one user of the at least one actual group based on the classification.

Clause 20: The system of any of clauses 11-19, wherein the at least one processor is programmed or configured to: generate at least one merchant recommendation based on the classification; and communicate at least one of an offer message and an advertisement message to a computing device of at least one user of the at least one actual group based on the at least one merchant recommendation.

Clause 21: A computer program product for group recommendation, the computer program product comprising at least one non-transitory computer-readable medium including one or more instructions that, when executed by at least one processor, cause the at least one processor to: generate a plurality of candidate groups based on transaction data associated with each user of a plurality of users, each candidate group of the plurality of candidate groups comprising a subset of users that conducted transactions with at least one common merchant within a threshold time; generate, a plurality of actual groups based on the plurality of candidate groups and the transaction data associated with each user of the plurality of users, each actual group of the plurality of actual groups comprising a subset of users grouped together in at least a threshold plurality of candidate groups; and for at least one actual group of the plurality of actual groups, determine a classification associated with a merchant for the at least one actual group based on transaction data for transactions conducted between the merchant and each user of the at least one actual group.

Clause 22: The computer program product of clause 21, wherein the at least one common merchant comprises a restaurant merchant.

Clause 23: The computer program product of clause 21 or 22, wherein the threshold time comprises up to 10 minutes.

Clause 24: The computer program product of any of clauses 21-23, wherein generating the plurality of actual groups comprises: based on the transaction data, generating a weight undirected graph wherein each node corresponds a user and each edge corresponds to two users being included in a same candidate group of the plurality of candidate groups, wherein each edge is assigned a weight based on a number of same candidate groups in which the two users have been included together.

Clause 25: The computer program product of any of clauses 21-24, wherein the threshold plurality of candidate groups comprises the weight exceeding a predetermined level.

Clause 26: The computer program product of any of clauses 21-25, wherein the classification is based on an amount spent at the merchant by at least one user of the at least one actual group.

Clause 27: The computer program product of any of clauses 21-26, wherein the classification is based on a number of times the at least one actual group has conducted transactions with the merchant.

Clause 28: The computer program product of any of clauses 21-27, wherein the one or more instructions cause the at least one processor to: receive group recommendation data from a recommendation engine generating at least one recommendation not based on user transaction data; compare at least one of the plurality of candidate groups, the plurality of actual groups, and the classification with the group recommendation data; and based on the comparison, generate a score associated with the recommendation engine.

Clause 29: The computer program product of any of clauses 21-28, wherein the one or more instructions cause the at least one processor to: communicate at least one of an offer message and an advertisement message to a computing device of at least one user of the at least one actual group based on the classification.

Clause 30: The computer program product of any of clauses 21-29, wherein the one or more instructions cause the at least one processor to: generate at least one merchant recommendation based on the classification; and communicate at least one of an offer message and an advertisement message to a computing device of at least one user of the at least one actual group based on the at least one merchant recommendation.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

Additional advantages and details of the disclosure are explained in greater detail below with reference to the non-limiting exemplary embodiments that are illustrated in the accompanying schematic figures, in which:

FIG. 1 shows a group recommendation system according to some non-limiting embodiments or aspects;

FIG. 2 shows a group recommendation system according to some non-limiting embodiments or aspects;

FIG. 3 shows a system for generating a plurality of candidate groups according to some non-limiting embodiments or aspects;

FIG. 4 shows a system for generating a plurality of actual groups according to some non-limiting embodiments or aspects;

FIG. 5 shows a system for generating a score associated with a recommendation engine according to some non-limiting embodiments or aspects; and

FIG. 6 shows a computer-implemented method for group recommendation according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “account identifier” may include one or more types of identifiers associated with a user account (e.g., a primary account number (PAN), a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a payment device (e.g., a portable payment instrument, a payment card, a credit card, a debit card, and/or the like) and/or may be electronic information communicated to the user that the user may use for electronic payments. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of identifier. Account identifiers may be alphanumeric, any combination of characters and/or symbols, and/or the like. An issuer institution may be associated with a bank identification number (BIN) that uniquely identifies the issuer institution.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “issuer institution” may refer to one or more entities, such as a bank, that provide accounts to users for conducting transactions (e.g., payment transactions), such as initiating credit and/or debit payments. For example, an issuer institution may provide an account identifier, such as a PAN, to a user that uniquely identifies one or more accounts associated with that user. The account identifier may be embodied on a payment device, such as a physical financial instrument, e.g., a payment card, and/or may be electronic and used for electronic payments. The term “issuer system” refers to one or more computer systems, computing devices, software applications, and/or the like operated by or on behalf of an issuer institution, such as a server computer executing one or more software applications. For example, an issuer system may include one or more authorization servers for authorizing a transaction, one or more authentication servers for authenticating a transaction, and/or one or more databases of account data. An issuer system may include a separate or integrated issuer authentication system, such as an Access Control Server (ACS), for authenticating online transactions. An issuer institution may be associated with a bank identification number (BIN) or other unique identifier that uniquely identifies it among other issuer institutions.

As used herein, the term “merchant” may refer to an individual or entity that provides goods and/or services, or access to goods and/or services, to users (e.g., consumers) based on a transaction (e.g., a payment transaction). The term “merchant system” may refer to one or more computer systems, computing devices, and/or software applications operated by or on behalf of a merchant, such as a server computer executing one or more software applications. A “point-of-sale (POS) system,” as used herein, may refer to one or more computers and/or peripheral devices used by a merchant to engage in payment transactions with users, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third-party for facilitating such online transactions.

As used herein, the term “payment device” may refer to a portable financial device, an electronic payment device, a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a PDA, a pager, a security card, a computer, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” As used herein, the term “server” or “processor” may refer to one or more devices that provide a functionality to one or more devices (e.g., one or more client devices) via a network (e.g., a public network, a private network, the Internet, and/or the like). For example, a server may include one or more computing devices. As used herein, the term “system” may refer to one or more devices, such as one or more processors, servers, client devices, computing devices that include software applications, and/or the like. In some non-limiting embodiments or aspects, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

Non-limiting embodiments or aspects of the present disclosure are directed to a computer-implemented method, system, and computer program product for group recommendation. Non-limiting embodiments or aspects enable group recommendations to be generated based on user transaction data, increasing the efficiency with which group recommendations may be generated and the accuracy of those generated recommendations. The group recommendations may be generated based on the determination that a user was a member of an actual group using the transaction data, rather than generating synthetic groups (non-actual groups) based on survey or evaluation data, which is more expensive to generate and less accurate for group recommendations. The generation of actual groups may be performed more accurately by non-limiting embodiments or aspects based on the evaluation of candidate groups based on transaction data and the frequency of the recurrence of those candidate groups, indicating a likelihood that a candidate group corresponds to an actual group. Non-limiting embodiments or aspects enable groups to receive offers, recommendations, and/or advertisements associated with merchants more likely to be relevant to their tastes based on the use of actual transaction data and the generation of actual groups. Non-limiting embodiments or aspects enable the evaluation (scoring) of alternative group recommendation engines not using actual transaction data to generate their recommendations, in order to evaluate the effectiveness of the algorithms.

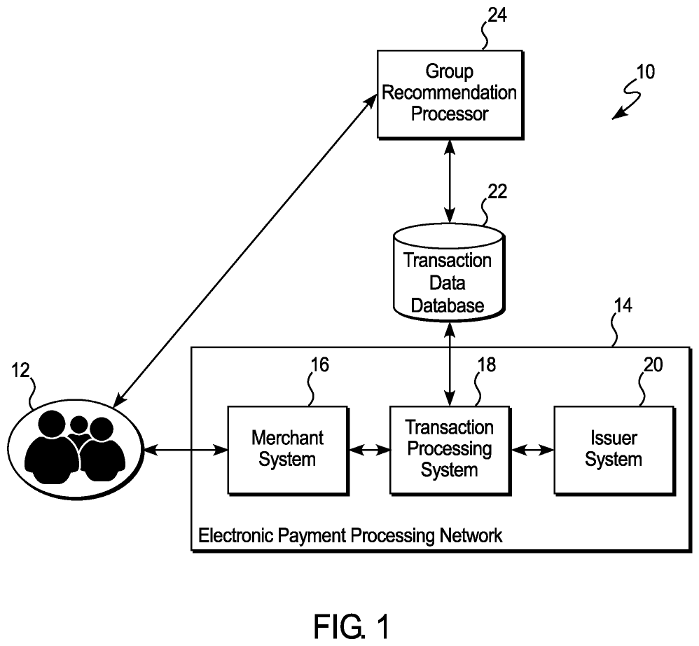

Referring to FIG. 1, a group recommendation system 10 is shown according to some non-limiting embodiments or aspects. The system 10 may include a plurality of users 12 (e.g., consumers) each engaging with an electronic payment processing network 14 to conduct electronic payment transactions.

The electronic payment transactions may be initiated by the users 12 initiating the transaction with the merchant system 16 operated by or on behalf of a merchant using a payment device. In response to the users initiating the electronic payment transactions with the payment device, the merchant system 16 may communicate a transaction request message to a transaction processing system 18 operated by or on behalf of a transaction service provider to cause the electronic payment transaction to be processed to completion (e.g., authorized, cleared, settled). The transaction processing system 18 may generate an authorization request message in response to receiving the transaction request message and may communicate the authorization request message to an issuer system 20 operated by or on behalf of an issuer associated with the payment device to cause the issuer to generate an authorization decision to approve the transaction, decline the transaction, or approve the transaction in part. The issuer may be the same entity or a different entity from the transaction service provider. The issuer system 20 may communicate an authorization response message containing the authorization decision to the transaction processing system 18. The transaction processing system 18 may communicate the authorization decision to the merchant system 16 in a transaction response message.

The above-described process executed by the electronic payment processing network 14 in response to users 12 initiating electronic payment transactions may be performed for each electronic payment transaction initiated by a user with a payment device. The various transaction messages (transaction request message, transaction response message, authorization request message, authorization response message) may be communicated according to ISO 8583. The transaction messages may include at least a portion of the data elements specified in ISO 8583 as transaction data, and this transaction data may be used in the processing of the electronic payment transaction. The transaction data is not limited to data elements specified in ISO 8583, and may also include additional data associated with, collected by, and/or generated by processing of the electronic payment transaction. Non-limiting examples of transaction data include user contact data (e.g., email address, phone number, etc.), user device data (e.g., unique identifier associated with a user computing device), line item data associated with user purchases, geolocation data (e.g., from the user device), and the like. The transaction data may be stored in a transaction data database 22 by the transaction processing system 18 during and/or after processing of electronic payment transactions.

With continued reference to FIG. 1, a group recommendation processor 24 may generate and/or evaluate group recommendations based on the transaction data stored in the transaction data database 22. The group recommendation processor 24 may be operated by or on behalf of the transaction service provider, the merchant, the issuer, or some other third party entity, such as another entity involved in processing electronic payment transactions. The group recommendation processor 24 may communicate with the users 12 (e.g., the computing devices associated therewith) in response to evaluating the transaction data, such as to communicate group recommendations.

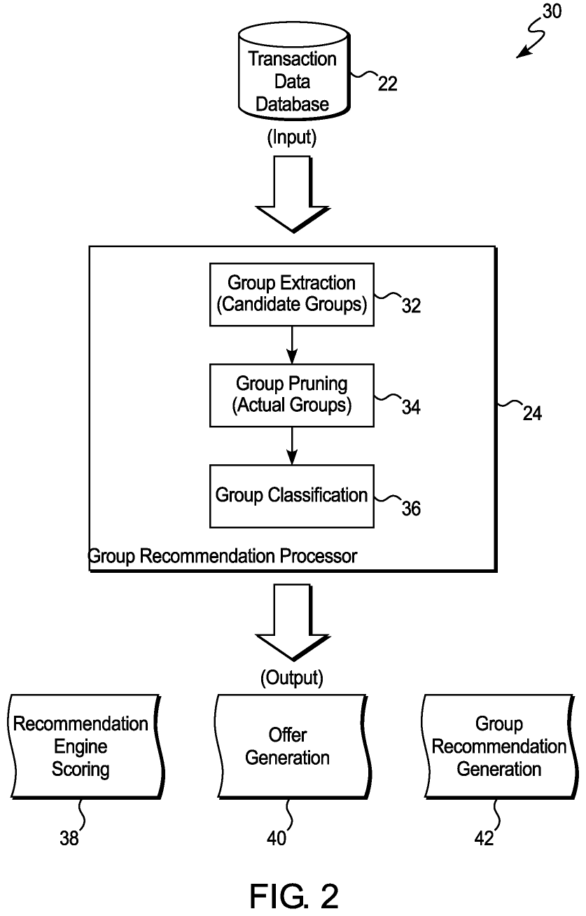

Referring to FIG. 2, a group recommendation system 30 is shown according to some non-limiting embodiments or aspects. Transaction data from the transaction data database 22 may be communicated to the group recommendation processor 24 for evaluation. The group recommendation processor 24 may perform a group extraction step 32. The group extraction step 32 may include generating a plurality of candidate groups based on the transaction data associated with each user of the users. The candidate groups may each include a subset of users that conducted electronic payment transactions with at least one common merchant within a threshold time.

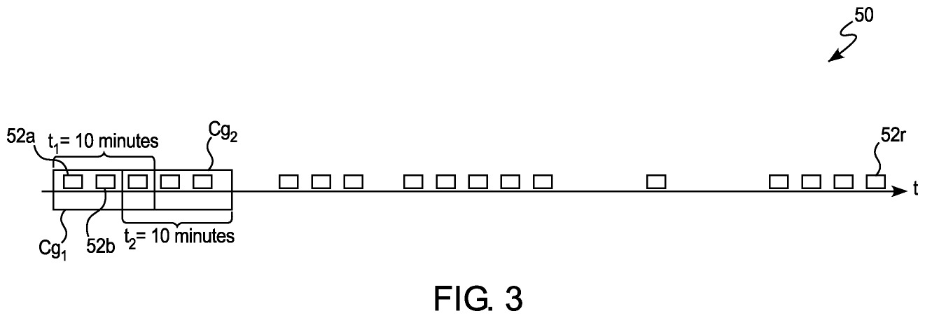

Referring to FIG. 3, a system 50 is shown for generating the candidate groups according to some non-limiting embodiments or aspects. A candidate group is defined as a group of users who have conducted an electronic payment transaction at a common merchant within a threshold time, such that there is a possibility that that group of users patronized the merchant as a concerted group. The system 50 may include a plurality of electronic payment transactions 52a, 52b . . . 52r, conducted at a merchant during a time period. For example, the system 50 may include the plurality of electronic payment transactions 52a, 52b . . . 52r conducted at the merchant over the course of one day, although other time periods may be contemplated, such as one week, one hour, and the like.

Candidate groups (e.g., cg1, cg2) may be determined based on the electronic payment transactions being initiated at the merchant within the common threshold. For example, the threshold may include a time of up to 10 minutes, such as up to 5 minutes, or up to 1 minute, such that electronic payment transactions initiated within 10 minutes of at least one other electronic payment transaction may form a candidate group (the users associated with those electronic payment transactions are grouped together). As such, all 10 minute windows within the time period may be evaluated to generate a plurality of candidate groups associated with that merchant during the time period. Other time thresholds longer or shorter than 10 minutes may be used depending on the group recommendation processor 24 determining the time window in which the users conducting transactions as a group are likely to initiate transactions within. The candidate groups cg1, cg2 may include a plurality of users.

The common merchant may be any type of merchant. The common merchant may be merchant at which groups of users are likely to patronize together, such as merchants associated with a group activity. The merchant may include a restaurant merchant. The merchant may include an entertainment merchant (e.g., a concert venue, a movie theater, a sporting event venue, a digital media merchant (e.g., a video or music streaming service), a group activity merchant, and the like). The merchant may include a travel merchant (e.g., an airline, a rideshare service, a hotel, a travel destination attraction merchant, and the like).

Referring again to FIG. 2, the group recommendation processor 24 may perform a group pruning step 34 to “prune” the candidate groups down to actual groups. During the group pruning step 34, certain candidate groups may be determined to be actual groups, while other candidate groups may be determined to be coincidental groups, not associated with actual groups. An actual group is defined as a group of users who have conducted an electronic payment transaction at a common merchant within a threshold time above a threshold number of times (appear in a threshold number of candidate groups), such that it is highly likely that the group of users patronized the merchant as a concerted group and is inferred to be an actual group. The term actual group does not necessarily mean that the group of users actually patronized the merchant as a concerted group, but that based on the number of times that group has patronized a same merchant together (within the threshold), the group recommendation processor 24 has determined that such activity is unlikely to be a coincidence and that it is highly likely that the group of users is acting in concert (patronizing the merchant as a group).

The group pruning step 34 may include generating a plurality of actual groups based on the plurality of candidate groups and the transaction data associated with each user of the users. The actual groups may each include a subset of users grouped together in at least a threshold plurality of candidate groups within a time period (e.g., a week, a month, a quarter, a year, etc.).

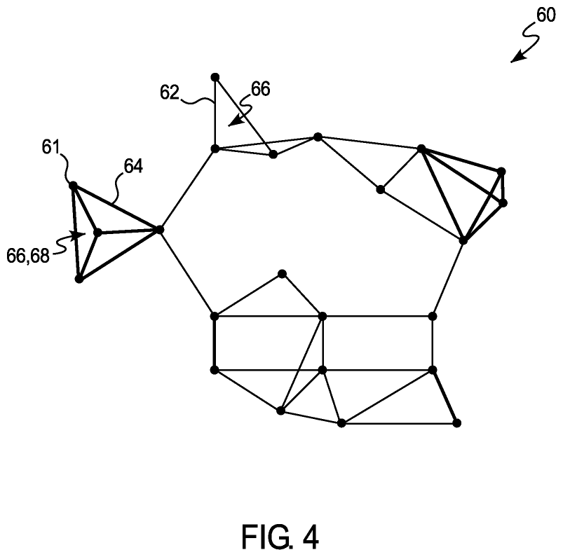

Referring to FIG. 4, a system 60 is shown for generating a plurality of actual groups according to some non-limiting embodiments or aspects. The system 60 may include an undirected graph generated using the transaction data. The undirected graph may be used to determine candidate group and actual groups. The undirected graph may include a plurality of nodes 61, each node corresponding to a user. The undirected graph may include edges 62, 64, each edge connecting two nodes. Each edge 62, 64 may correspond to two users being included in the same candidate group of the plurality of candidate groups (the two users conducted a transaction at a common merchant within a threshold during the time period). The undirected graph may be specific to a merchant or may be generated based on a plurality of merchant transactions, such that groups patronizing a plurality of merchants may be detected. The edges 62, 64 may be assigned a weight based on a number of same candidate groups in which two users have been included together. The weight may be indicated using any number of techniques. In the non-limiting example shown in FIG. 4, weight is indicated by line thickness, such that lighter edges 62 (thinner lines) correspond to two users who share fewer candidate groups and heavier edges 64 (thicker lines) correspond to two users who share more candidate groups. Other methods of indicating weight of edges, such as associating integers (corresponding to the number of common candidate groups) with the edges 62, 64 may be used.

Based on the weight of the edges 62, 64, the group recommendation system 24 (see FIGS. 1 and 2) may determine which candidate groups correspond to actual groups, such that the threshold level of candidate groups is represented by the weight of the edges 62, 64 exceeding a predetermined level.

In the non-limiting example shown in FIG. 4, 14 of the edges are heavier edges (relative to the remaining lighter edges). Those 14 edges correspond to 4 candidate groups being determined to be actual groups, with the weight of the heavier edges corresponding to the predetermined level at which a groups is determined to be an actual group. These 4 actual groups include 2 groups of 2 and 2 groups of 4. As a non-limiting example, the triangle labeled 66 includes all lighter edges, such that it corresponds to a candidate group 66 but not an actual group. As a non-limiting example, the pyramid labeled 66, 68 includes all heavier edges such that it corresponds to a candidate group 66 and an actual group 68 including more than two users.

While the above-describe example from FIG. 4 shows the group recommendation system 24 generating the undirected graph to determine at least one of the candidate groups and the actual groups, it will be appreciated that other computer-implemented techniques may be used to determine candidate groups and whether those candidate groups correspond to actual groups.

Referring again to FIG. 2, the group recommendation processor 24 may perform a group classification step 36 to determine a classification for each generated actual group. The classification may be associated with the merchant patronized by the actual group. The classification may be based on transaction data for transactions conducted between the merchant and each user of the actual group. The classification may represent whether each user of the actual group and/or the group as a whole views the merchant favorably, unfavorably, or neutral.

Determining the classification may include analyzing an amount spent at the merchant by at least one user of the actual group. In some non-limiting embodiments or aspects, an aggregate amount spent by the group is analyzed against statistical data associated with that merchant or similar merchants to determine whether the group spent a larger or smaller amount compared to the average. Larger amount spent by the group (e.g., in total or an average per person) may result in a more favorable classification for the actual group associated with the merchant than a smaller amount spent by the group. In some non-limiting embodiments or aspects, amount spent by each individual user may be analyzed against statistical data associated with the merchant or similar merchant to determine whether individual users each spent a large or smaller amount compared to the average, or based on a percentile breakdown of user spending at the merchant. More group members spending more at the merchant may result in a more favorable classification for the actual group associated with the merchant than fewer group members spending more at the merchant.

In some non-limiting embodiments or aspects, each user's amount spent is analyzed, and each user is assigned a classification associated with the merchant. The group classification may be based on the number of users in the group that have been assigned a favorable classification, an unfavorable classification, or a neutral classification.

In some non-limiting embodiments or aspects, the classification may be based on a number of times that the actual group has conducted transactions with the merchant over a time period (e.g., a week, a month, a quarter, a year, etc.). An actual group that has conducted a higher number of transactions at the merchant may be assigned a more favorable classification associated with the merchant than an actual group that has conducted fewer transactions at the merchant.

The group classification may include labels, such as that the group “likes”, “dislikes”, or is “neutral” to the merchant. The classifications may include a favorability score or grade corresponding to how favorably the group is determined to view the merchant.

Referring again to FIG. 2, upon performing the group extraction step 32, the group pruning step 34, and the group classification step 36, the group recommendation processor 24 may generate an output communication. The output communication may include at least one of a recommendation engine scoring 38, an offer or advertisement 40, and a group recommendation 42, each of which will be described in more detail hereinafter.

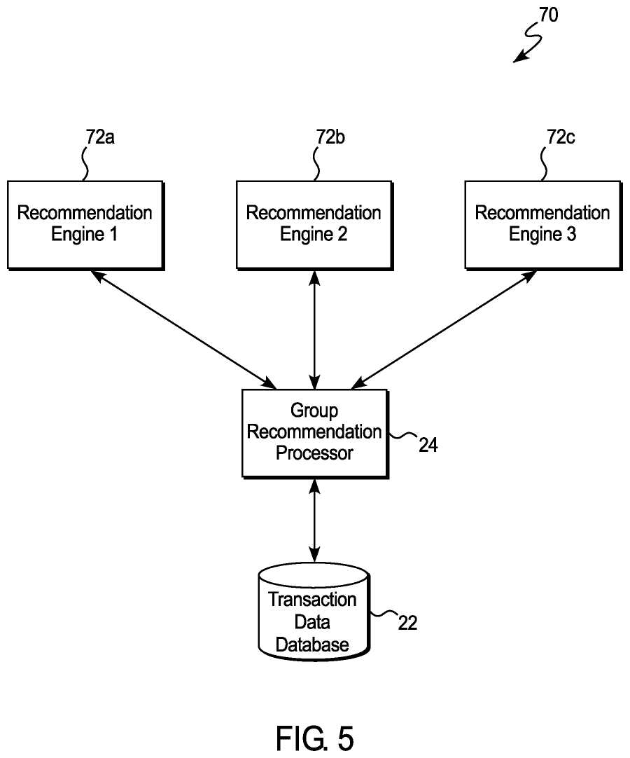

Referring to FIG. 5, with respect to the recommendation engine scoring 38 (from FIG. 2), a system 70 is shown for generating a score associated with a recommendation engine according to some non-limiting embodiments or aspects. The system 70 may include the group recommendation processor 24 in communication with at least one recommendation engine 72a-72c. Each recommendation engine 72a-72c may generate group recommendations (an example of group recommendation data) using a different algorithm. The recommendation engine 72a-72c may generate group recommendation data; however, this group recommendation data may not be based on user transaction data (e.g., not from the transaction data database 22). For example, the group recommendation data may be based on survey data from questions asked to users in a survey. As such, because actual transaction data is used by the group recommendation processor 24 and is not used by the at least one recommendation engine 72a-72c, the group recommendation processor 24 may be used as a baseline for determining the accuracy of the group recommendation data generated by the at least one recommendation engine 72a-72c.

With continued reference to FIG. 5, the group recommendation processor 24 may receive group recommendation data from at least one recommendation engine 72a-72c. The group recommendation processor 24 may analyze the group recommendation data in order to generate a score associated with the at least one recommendation engine 72a-72c. The score may indicate an accuracy associated with the group recommendations or other group recommendation data generated by the at least one recommendation engine 72a-72c. The score may be generated in any form, such as a numerical score, a letter grade, a pass/fail, or any other known scoring representation that conveys the accuracy of the recommendations generated by the at least one recommendation engine 72a-72c. The group recommendation processor 24 may communicate the score to the at least one recommendation engine 72a-72c. The score may be based on the classifications the at least one recommendation engine 72a-72c assigns to the merchants for a group, the accuracy of the merchants recommended for the group as similar merchants, and the like.

The group recommendation processor 24 may analyze the group recommendation data by comparing the group recommendation data with at least one of the plurality of candidate groups, plurality of actual groups, and the classification generated or determined by the group recommendation processor 24. The group recommendation data may be compared to the plurality of candidate groups, plurality of actual groups, and the classification generated or determined by the group recommendation processor 24 associated with a specific user, a subset of users, or a merchant. In some non-limiting embodiments or aspects, the plurality of actual groups generated by the group recommendation processor 24 may be compared against group recommendation data from the at least one recommendation engine 72a-72c, which group recommendation data comprises groups ascertained by the algorithm used by the at least one recommendation engine 72a-72c (e.g., to see how accurately the at least one recommendation engine 72a-72c identifies actual groups). In some non-limiting embodiments or aspects, the classification for an actual group determined by the group recommendation processor 24 may be compared against group recommendation data from the at least one recommendation engine 72a-72c, which group recommendation data comprises a classification associated with the same group or a user therein (e.g., to see how accurately the at least one recommendation engine 72a-72c determines a classification associated with the group).

With continued reference to FIG. 5, with respect to the recommendation engine scoring 38 (from FIG. 2), the system 70 may include the group recommendation processor 24 communicating at least a portion of the transaction data from the transaction data database 22 to the at least one recommendation engine 72a-72c as training data. The at least one recommendation engine 72a-72c may train its algorithm based on the transaction data from the group recommendation processor 24 and/or may adjust and/or refine its algorithm based on the training data. The group recommendation processor 24 may communicate test data from the transaction data to the at least one recommendation engine 72a-72c, which may return group recommendations based on the test data. The group recommendation processor may analyze these generated recommendations and score the at least one recommendation engine's 72a-72c group recommendations for the test data to generate a score for the at least one recommendation engine 72a-72c. The comparison may be made to the group recommendation processor's 24 output in connection with the same test data.

Referring again to FIG. 1, with respect to the offer or advertisement 40 (from FIG. 2), the group recommendation processor 24 may communicate with at least one of the users 12, such as communicating with a computing device thereof (e.g., an email, a text message, a telephone call, and the like). The group recommendation processor 24 may communicate at least one of an offer message or an advertisement message to the computing device of the at least one user 12 of the actual group for which the classification was determined. The offer message may include an offer, such as a discount or other benefit redeemable by the at least one user 12 associated with the merchant associated with the classification or other merchant recommended by the group recommendation processor 24. The offer may be associated with a future purchase initiated by a plurality of users defined as the actual group for which the classification was generated (or a subset of users therefrom). The users may redeem the offer at a future transaction with the merchant associated with the offer message. The advertisement message may include an advertisement associated with the merchant associated with the classification or other merchant recommended by the group recommendation processor 24. The offer message or the advertisement message may be communicated to a single user of the actual group or simultaneously to each user in the actual group.

Referring again to FIG. 1, with respect to the group recommendation 42 (from FIG. 2), the group recommendation processor 24 may generate a merchant recommendation based on the classification. The merchant from the merchant recommendation may be a different merchant from the merchant of the classification. The merchant recommendation may be based on transaction data indicating that the merchant of the merchant recommendation is similar to (e.g., has similar products or services or types of products or services) the merchant associated with the classification. The merchant recommendation may be based on location data indicating that the merchant of the merchant recommendation is located proximate the merchant associated with the classification. The merchant recommendation may be based on transaction data indicating that other users or groups of users who received a favorable classification for the merchant associated with the classification also had a favorable classification for the recommended merchant (e.g., both merchants were viewed favorably by similar users or groups of users). The merchant recommendation may be based on any other relevant criteria. Machine learning algorithms may be used to generate the merchant recommendation.

The merchant recommendation may be communicated to at least one user 12 in the actual group. At least one of an offer message and an advertisement message associated with the recommended merchant may be communicated to the at least one user 12 in the actual group, as described above.

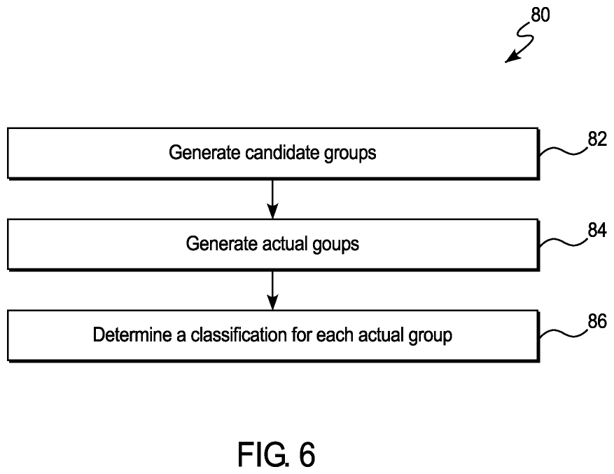

Referring to FIG. 6, a computer-implemented method 80 is shown for group recommendation according to some non-limiting embodiments or aspects. At a step 82, the group recommendation processor may generate a plurality of candidate groups based on transaction data associated with each user of a plurality of users. Each candidate group of the plurality of candidate groups may include a subset of users that conducted transactions with at least one common merchant within a threshold time.

At a step 84, the group recommendation processor may generate a plurality of actual groups based on the plurality of candidate groups and the transaction data associated with each user of the plurality of users. Each actual group of the plurality of actual groups may include a subset of users grouped together in at least a threshold plurality of candidate groups.

At a step 86, the group recommendation processor may, for at least one actual group of the plurality of actual groups, determine a classification associated with a merchant for the at least one actual group based on transaction data for transactions conducted between the merchant and each user of the at least one actual group.

In a further, non-limiting embodiment or aspect, a computer program product for group recommendation includes at least one non-transitory computer readable medium including program instructions that, when executed by at least one processor, cause the at least one processor to execute one of the previously-described methods. The at least one processor may include the group recommendation processor.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

The invention claimed is:

1. A computer-implemented method, comprising:
generating, with at least one processor, a plurality of candidate groups based on transaction data associated with each user of a plurality of users, each candidate group of the plurality of candidate groups comprising a subset of users that conducted transactions with at least one common merchant within a threshold time;
generating, with at least one processor, a plurality of actual groups based on the plurality of candidate groups and the transaction data associated with each user of the plurality of users, each actual group of the plurality of actual groups comprising a subset of users grouped together in at least a threshold plurality of candidate groups; and
for at least one actual group of the plurality of actual groups, determining, with at least one processor, a classification associated with a merchant for the at least one actual group based on transaction data for transactions conducted between the merchant and each user of the at least one actual group.

2. The method of claim 1, wherein the at least one common merchant comprises a restaurant merchant.

3. The method of claim 1, wherein the threshold time comprises up to 10 minutes.

4. The method of claim 1, wherein generating the plurality of actual groups comprises:
based on the transaction data, generating, with at least one processor, a weight undirected graph wherein each node corresponds a user and each edge corresponds to two users being included in a same candidate group of the plurality of candidate groups, wherein each edge is assigned a weight based on a number of same candidate groups in which the two users have been included together.

5. The method of claim 4, wherein the threshold plurality of candidate groups comprises the weight exceeding a predetermined level.

6. The method of claim 1, wherein the classification is based on an amount spent at the merchant by at least one user of the at least one actual group.

7. The method of claim 1, wherein the classification is based on a number of times the at least one actual group has conducted transactions with the merchant.

8. The method of claim 1, further comprising:
receiving, with at least one processor, group recommendation data from a recommendation engine generating at least one recommendation not based on user transaction data;
comparing, with at least one processor, at least one of the plurality of candidate groups, the plurality of actual groups, and the classification with the group recommendation data; and
based on the comparison, generating, with at least one processor, a score associated with the recommendation engine.

9. The method of claim 1, further comprising:
communicating, with at least one processor, at least one of an offer message and an advertisement message to a computing device of at least one user of the at least one actual group based on the classification.

10. The method of claim 1, further comprising:
generating, with at least one processor, at least one merchant recommendation based on the classification; and
communicating, with at least one processor, at least one of an offer message and an advertisement message to a computing device of at least one user of the at least one actual group based on the at least one merchant recommendation.

11. A group recommendation system, comprising at least one processor programmed or configured to:
generate a plurality of candidate groups based on transaction data associated with each user of a plurality of users, each candidate group of the plurality of candidate groups comprising a subset of users that conducted transactions with at least one common merchant within a threshold time;
generate, a plurality of actual groups based on the plurality of candidate groups and the transaction data associated with each user of the plurality of users, each actual group of the plurality of actual groups comprising a subset of users grouped together in at least a threshold plurality of candidate groups; and
for at least one actual group of the plurality of actual groups, determine a classification associated with a merchant for the at least one actual group based on transaction data for transactions conducted between the merchant and each user of the at least one actual group.

12. The system of claim 11, wherein the at least one common merchant comprises a restaurant merchant.

13. The system of claim 11, wherein the threshold time comprises up to 10 minutes.

14. The system of claim 11, wherein generating the plurality of actual groups comprises:
based on the transaction data, generating a weight undirected graph wherein each node corresponds a user and each edge corresponds to two users being included in a same candidate group of the plurality of candidate groups, wherein each edge is assigned a weight based on a number of same candidate groups in which the two users have been included together.

15. The system of claim 14, wherein the threshold plurality of candidate groups comprises the weight exceeding a predetermined level.

16. The system of claim 11, wherein the classification is based on an amount spent at the merchant by at least one user of the at least one actual group.

17. The system of claim 11, wherein the classification is based on a number of times the at least one actual group has conducted transactions with the merchant.

18. The system of claim 11, wherein the at least one processor is programmed or configured to:
receive group recommendation data from a recommendation engine generating at least one recommendation not based on user transaction data;
compare at least one of the plurality of candidate groups, the plurality of actual groups, and the classification with the group recommendation data; and
based on the comparison, generate a score associated with the recommendation engine.

19. The system of claim 11, wherein the at least one processor is programmed or configured to:
communicate at least one of an offer message and an advertisement message to a computing device of at least one user of the at least one actual group based on the classification.

20. The system of claim 11, wherein the at least one processor is programmed or configured to:
generate at least one merchant recommendation based on the classification; and
communicate at least one of an offer message and an advertisement message to a computing device of at least one user of the at least one actual group based on the at least one merchant recommendation.
